(19) United States
(12) Patent Application Publication
(10) Pub. No.: US 2009/0298463 A1
(43) Pub. Date: Dec. 3, 2009

(54) SYSTEM AND METHOD FOR SEARCHING FOR MOST ECONOMICAL CALL MODE

(75) Inventor: YA-BEI ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/237,229

(22) Filed: Sep. 24, 2008

(30) Foreign Application Priority Data
May 30, 2008 (CN) 200810301865.6

(51) Int. Cl. H04M 11/00

(52) U.S. Cl. 455/406

(57) ABSTRACT

A system for searching for a most economical call mode includes a mobile phone, a network, and a user terminal. The mobile phone includes a dialing module, an information acquisition module, a calculation controlling module, an instant messaging module, and a database storing a plurality of calling fee standards. The user terminal is capable of communicating with the mobile phone through the network. The user terminal includes a first call terminal and a second call terminal. An instant messaging software is embedded in the second call terminal. The information acquisition module is started up, and the instant messaging module determines if the second call terminal is on-line. If the second call terminal is on-line, the calculation controlling module is started up to calculate the most economical call mode via searching in the database, and suggests selecting the most economical call mode to establish a communication.

### BACKGROUND

1. Field of the Invention

The present invention relates to systems and methods for searching call modes and, more particularly, to a system and a method for automatically searching for a most economical call mode through a mobile phone.

2. Description of Related Art

Mobile phones are becoming increasingly popular, and calling fees for mobile phones have become the focus of attention.

Nowadays, a variety of call modes such as direct dialing phone numbers, instant messaging, and chatting over the Internet are available for a mobile phone. However, the calling fee of each call mode may be different, and it is difficult for a user to quickly determine and select a most economical call mode.

What is needed, therefore, is a system and a method for automatically searching for a most economical call mode through a mobile phone.

### BRIEF DESCRIPTION OF THE DRAWINGS

FIG. 1 is a schematic diagram of one embodiment of a system for searching for a most economical call mode; and

FIG. 2 is a flow chart of one embodiment of a method for searching for a most economical call mode.

### DETAILED DESCRIPTION OF THE EMBODIMENTS

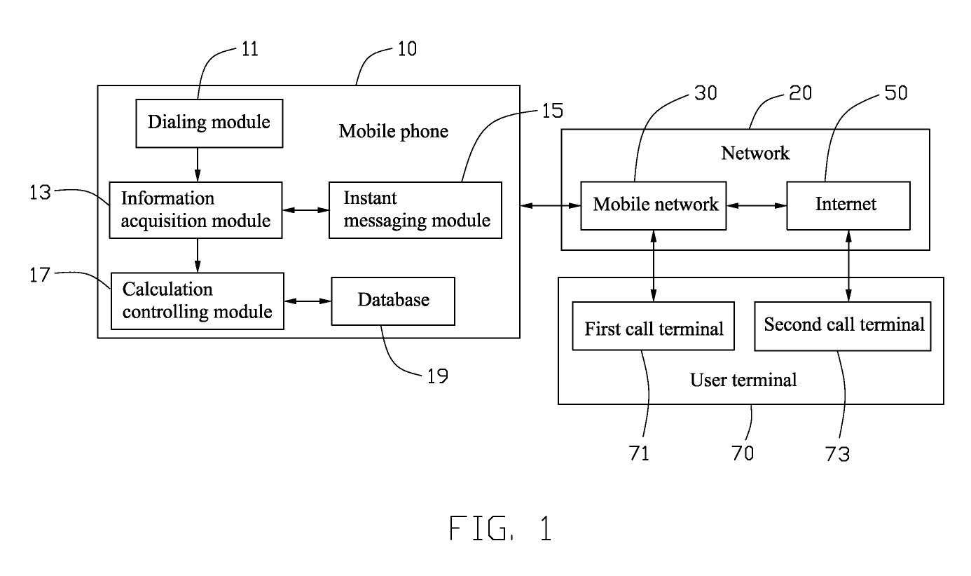

Referring to FIG. 1, one embodiment of a system for searching for a most economical call mode includes a mobile phone 10, a network 20 connected to the mobile phone 10, and a user terminal 70 connected to the network 20. The network 20 includes a mobile network 30 connected to the mobile phone 10 and an Internet 50 connected to the mobile network 30. The user terminal 70 includes a first call terminal 71 connected to the mobile network 30 and a second call terminal 73 connected to the Internet 50.

The mobile phone 10 includes a dialing module 11, an information acquisition module 13, a calculation controlling module 17, an instant messaging module 15, and a database 19. The instant messaging module 15 is configured with an instant messaging software having a speech chatting function. The database 19 stores call related information. The call related information includes a plurality of different calling fee standards. The first call terminal 71 may be a common telephone or a mobile terminal, and has a phone number of the common telephone or the mobile terminal. The second call terminal 73 may be a computer or a mobile terminal, has an instant messaging number, and configured to run an instant messaging software.

The phone number of the first call terminal 71 and the instant messaging number of the second call terminal 73 are stored in the mobile phone 10 so a user of the mobile phone 10 can conveniently call the user terminal 70.

When the user of the mobile phone 10 calls the user terminal 70, a name or a phone number of the user terminal 70 is inputted to the mobile phone 10 by the user, and the dialing module 11 is started up. The information acquisition module 13 is started up by the dialing module 11, and then the instant messaging module 15 is started up by the information acquisition module 13 to determine if the second call terminal 73 is on-line.

If the second call terminal 73 is on-line, the calculation controlling module 17 is started up by the information acquisition module 13. The calculation controlling module 17 calculates a most economical call mode by searching the database 19 to compare a cost of calling the first call terminal 71 through the mobile network 30 to a cost of calling the second call terminal 73 through the Internet 50. Then, the mobile phone 10 suggests via a display of the mobile phone 10, the most economical call mode. The user does not need to select the most economical mode and can still select any mode available for the call. If the user selects calling the first call terminal 71 by dialing the phone number of the first call terminal 71, the mobile phone 10 will be connected to the first call terminal 71 through the mobile network 30. If the user selects calling the second call terminal 73 via the instant messaging software, the mobile phone 10 will be connected to the second call terminal 73 through the mobile network 30 and the Internet 50.

If the second call terminal 73 of the user terminal 70 is not on-line, the mobile phone 10 will be directly connected to the first call terminal 71 through the mobile network 30.

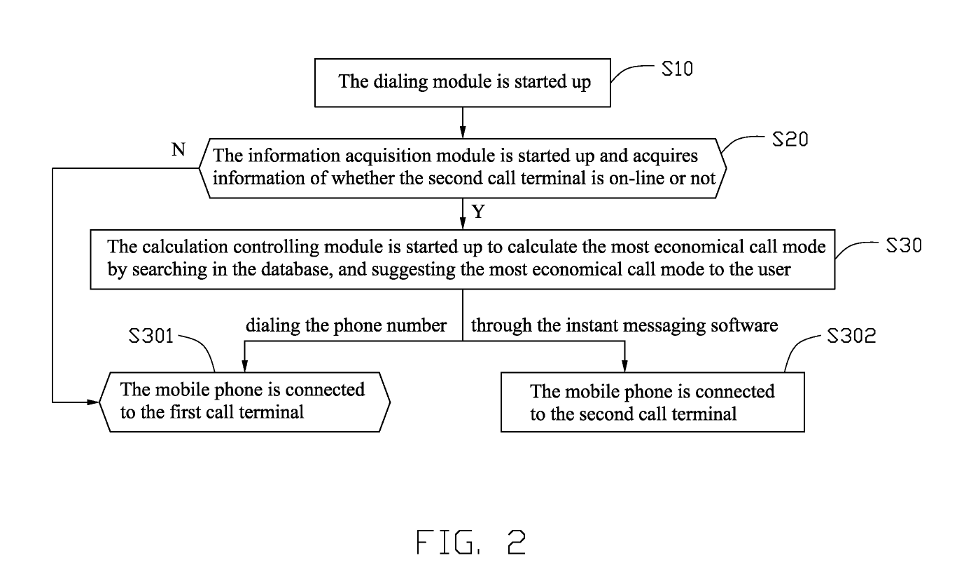

Referring to FIG. 2, a flowchart of a method utilizing the above described system for searching for the most economical call mode is shown. Depending on the embodiment, certain of the steps described below may be removed, others may be added, and the sequence of steps may be altered.
Step S10: The user inputs the name or the phone number of the user terminal 70 to the mobile phone 10, and the dialing module 11 is started up;
Step S20: The information acquisition module 13 is started up by the dialing module 11 to communicate with the instant messaging module 15, and then acquires information of whether the second call terminal 73 of the user terminal 70 is on-line or not; if the second call terminal 73 is not on-line, the method continues to step S301 and the mobile phone 10 will be connected to the first call terminal 71; if the second call terminal 73 is on-line, the method continues to step S30;
Step S30: If the second call terminal 73 is on-line, the calculation controlling module 17 is started up to calculate the most economical call mode by searching in the database 19 and suggesting the most economical call mode to the user;
Step S301: If the user selects the call mode of dialing the phone number, the mobile phone 10 will be connected to the first call terminal 71 through the mobile network 30;
Step S302: If the user selects the call mode through the instant messaging software, the mobile phone 10 will be connected to the second call terminal 73 through the mobile network 30 and the Internet 50;

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A system for searching for a most economical call mode, the system comprising:
a mobile phone comprising a dialing module, an information acquisition module connected to the dialing module, a calculation controlling module connected to the information acquisition module, an instant messaging module, and a database storing a plurality of calling fee standards;
a network;
a user terminal communicating with the mobile phone through the network, the user terminal comprising a first call terminal, and a second call terminal;
wherein an instant messaging software is embedded in the second call terminal; the information acquisition module is started up by the dialing module to make the instant messaging module determine if the second call terminal is on-line; if the second call terminal is on-line, the calculation controlling module is started up by the information acquisition module to calculate the most economical call mode for calling the user terminal via searching the database, and suggests selecting the most economical call mode to establish a communication.

2. The system of claim 1, wherein the first call terminal is a common phone, the second call terminal executes the instant messaging software; the second call terminal is selected from the group consisting of a computer and a mobile terminal capable running the instant messaging software.

3. The system of claim 2, wherein the network includes a mobile network and an Internet, the mobile phone communicates with the first call terminal through the mobile network, and communicates with the second call terminal through the mobile network and the Internet.

4. The system of claim 3, wherein the mobile phone stores a phone number of the first call terminal and an instant messaging number of the second call terminal.

5. The system of claim 4, wherein if the second call terminal is not on-line, the mobile phone will be connected to the first call terminal.

6. The system of claim 1, wherein the instant messaging module is an instant messaging software having a speech chatting function.

7. A method for searching for a most economical call mode to call a user terminal through a mobile phone, the method comprising:
determining if a second call terminal of the user terminal, capable of running an instant messaging software, is on-line over a network;
if the second call terminal is on-line, calculating the most economical call mode by searching in a database of the mobile phone, wherein the database stores a plurality of calling fee standards.

8. The method of claim 7, wherein if the second call terminal is not on-line, the mobile phone will be connected to a first call terminal of the user terminal.

9. The method of claim 8, wherein the network comprises a mobile network and an Internet, the mobile phone is capable of communicating with the first call terminal through the mobile network, and communicating with the second call terminal through the mobile network and the Internet.

10. The method of claim 9, wherein the first call terminal is a common phone, the second call terminal is selected from the group consisting of a computer and a mobile terminal.

11. The method of claim 10, further comprising storing a phone number of the first call terminal and an instant messaging number of the second call terminal in the mobile phone.

12. The method of claim 7, wherein the determining is performed by an instant messaging module embedded in the mobile phone.

13. The method of claim 7, wherein the calculating is performed by a calculation controlling module in the mobile phone.
